(19) United States
(12) Patent Application Publication
(10) Pub. No.: US 2012/0261083 A1
(43) Pub. Date: Oct. 18, 2012

(54) Modular Window Panels

(76) Inventor: Patrick Kenneth Daly, Miami, FL (US)

(21) Appl. No.: 13/086,380

(22) Filed: Apr. 13, 2011

(51) Int. Cl. E06B 9/24; A44B 19/24

(52) U.S. Cl. 160/236; 24/382

(57) ABSTRACT

A series of modular fabric panels interconnected by zippers to form a modular window or glass door covering system of various sizes. The panels can be adjusted to extend in either width, length or combination thereof. The zippers and components create seams made to be undetectable or unnoticed without buckling, opening or exposing the zipper, thus producing a customized curtain, while keeping the natural flow of the window covering.

### BACKGROUND OF THE INVENTION

1. Field of the Invention

The present invention relates generally to modular curtain panel, which connect to each other vertically or horizontally or a combination of both to custom fit a desired window size comprising specific types of zippers, zipper tape, zipper flaps, zipper location, and weights to conceal the seams and keeps the natural flow of the window covering.

2. Description of Related Art

The modular curtains panels are developed with horizontal or vertical zipper or both a combination of both thereof, depending in the environment they will be used in. Both in residential and hospitality, the needs and problems, in various instance are different to overcome.

The residential standard large curtain sizes vary, however there are certain sizes which are most widely used for either large windows or glass sliding doors. Presently, in the residential market, there are two types of curtains available: panels and custom.

The residential panel curtains usually fit only a standard size window with usually a maximum width of about 55 inches (fabric width, not always actual coverage of the panel) and can be found (in the United States) in lengths of 84, 96 and 108 inches, however if the window is of a different measurement, the user needs to purchase custom curtains or another type of window covering.

Residential custom window curtains are expensive and are made to fit the window they are made for. If one moves to another house or apartment, most of the time the custom curtains cannot be taken, since they probably fit the window they were made for, however modular curtain panels, have the ability to fit various windows they are not specifically made for, by attaching or detaching parts.

Large custom curtains are usually larger than panels, if the curtains becomes soiled, the entire curtain must be removed and cleaned professionally; however, with the modular curtain panel, the specific panel which is soiled can be removed and washed in a residential washing machine and then dried in a residential clothes drier. Each panel can include a wash bag with every panel, this would help avoid the panel from being stretched or pulled in the washing machine, thus preventing distortion.

Most people cannot visualize how curtains look in their house prior to hanging them. After the custom curtain is made and installed, if the customer does not like how it looks, they cannot return it, whereby the modular curtain panel, which are store or internet bought, most of the time can be returned or exchanged, with no problem.

Residential custom curtains are usually very expensive, however the custom modular panels can be purchased approximately the same price as a regular panel.

The use the custom modular curtains is different for hospitality. Most countries hospitality curtains must be fire rated, so standard panels sold in a store cannot be used for hospitality, plus the criterion and needs for a hospitality curtain many times differs from that of a residential curtain.

Hospitality curtains become soiled, burned or ruined at a much faster rate than residential, thus occurring in the lower 75% of the curtain. On a two part panel modular curtain panel, the top part could be about 25% of the length of the curtain, so the bottom part, where most of the problems occur, can be replaced within minutes. Since the top part does not have detached from the horizontal rod suspending it, housekeeping can replace it within minutes and the room can be ready for the next guest, thus professional help is not needed in replacing the curtain parts.

Some hotels may have issues with their curtains fraying, becoming dirty or ruined at the edges, from opening and closing the curtain and is some occasions, from blowing out the window. The problem can be solved with a small vertical addition to the curtain, which can easily be changed and cost much less than replacing the entire curtain.

U.S. Pat. No. 3,883,381 (1975) to Thaeler discloses a method of installing a slide fasteners having the main fabric sections folded upon themselves to form a pair of flaps, compressing the flaps to the main section and bonding with heat.

U.S. Pat. No. 4,631,765 (1986) to Casey discloses a method using fasteners to attach the marginal edges to permit detachable connection of modules to quilts, sleeping bags, windows, wall or floor ceiling coverings and the like.

U.S. Pat. No. 5,592,691 (1997) to Ronald discloses a modular panel for fabricating clothing or accessories, fastened by means of a zipper.

U.S. Pat. Application No. 20100051214 (2010) to Daly discloses a two part modular curtain panel attached by a zippers; information not fully nor properly disclosed.

### SUMMARY OF THE INVENTION

The present invention provides curtain panels joined with zippers vertically or horizontally or a combination thereof, remaining undetectable, unnoticed, easily and quickly attached and removed, and the ability to mass produce efficient and consistently.

One embodiment of the present invention is the horizontal zipper used in the two part panel, which attaches the top part panel to the bottom part panel. The bottom panel top edge is attached to the top panels bottom edge in order to cover any distortion the zipper creates on the fabric, keeping the seamed area attached by zippers undetectable and unnoticeable. The zipper is located at the lower end of the top panels lining in order to distance the zipper from the front fabric. The horizontal zipper attached to the lining and its location on the lining, represent the decisive factor to make product structurally work. The zippers should not be located where the front and back fabric are sewn together since this would create approximately the same problem as sewing the zipper to the front fabric. The problems mentioned occur when the zippers are sewn horizontally not vertically, keeping in mind the flow of the curtains “S curve”.

In another embodiment of the present invention is the vertical zipper for the one or two part panel. The vertical zipper type comprising a coil, invisible, open ended, or similar (comparable to the type of flexibility of a coil zipper, which is inherently different from most zippers, with flat side or a side that does not protrude), the zippers and components are made of nylon, polyester or a similar synthetic material which keeps dimensionally stable, will not distort, contort, pucker or warp, thus the zippers stay straight, extended, even and flat in form to remain undetectable or unnoticed. The key idea is to keep the zippers undetectable or unnoticeable, thus a combination of several factor mentioned in the claims are essential to make the product work, which include: 1. the weights at the bottom part of the curtain (close to the zipper), which further hold the zipper keep straight and avoids the zipper from slightly deforming or contorting, plus keeping the corners of the curtain down, 2. the flaps covering the zippers, which are specific in size, to cover the zippers at all times, 3. the location of the zipper, which keeps the zipper from being exposed; each factor has details of construction which work with each other to make the product function, for example: without the weights located close to the bottom of the zipper, when the panels are attached side by side, the zippers will not only slightly contort, thus the zippers location would change from positioning down the crest, to positioning up the crest and thus exposing the zippers, and with the longer the zippers, more distortion would occur.

Previous inventions are very broad and combine various different products into one specification to suit all products. As detailed in this invention, panel curtains are specific to themselves, no other patented invention specifically targets panel curtains, thus their construction cannot be compared to that of a pillow, comforter, sleeping bag, clothing or a generic fabric attached by fasteners, since the parameter are clearly different. Other objects and advantages of this invention become apparent from the description taken in connection with the accompanying drawings, wherein set forth by way of illustration and example, embodiments of this invention.

### A BRIEF DESCRIPTION OF SEVERAL VIEWS OF THE DRAWINGS

These and other details of my invention will be described in the connection with the accompanying drawings, which are furnished only by way of illustration and not in limitation of the invention, and in which the drawings:

FIG. 1 is an elevation view of the two part panel back side of the top panel (facing the window) with a horizontal zipper.

FIG. 2 is an elevation view of the two part panel back side of the bottom panel (facing the window) with a horizontal zipper.

FIG. 3 is an elevation view of the back side of the two part panel top part (facing the window) with horizontal and vertical zippers; further detail on FIG. 5,6,7,8.

FIG. 4 is an elevation view of the back side of the two part panel bottom part (facing the window) with horizontal and vertical zippers; further detail on FIG. 9,10,11,12.

FIG. 5 is an elevation view of the back side of the two part panel top part, left hand side top corner.

FIG. 6 is an elevation view of the back side of the two part panel top part, right hand side top corner.

FIG. 7 is an elevation view of the back side of the two part panel top part, left hand side bottom corner.

FIG. 8 is an elevation view of the back side of the two part panel top part, right hand side bottom corner.

FIG. 9 is an elevation view of the back side of the two part panel bottom part, left hand side top corner.

FIG. 10 is an elevation view of the back side of the two part panel bottom part, hand side top corner.

FIG. 11 is an elevation view of the back side of the two part panel bottom part, left hand bottom corner.

FIG. 12 is an elevation view of the back side of the two part panel bottom part, right hand bottom corner.

FIG. 13 is an elevation view of the back side of the one part panel.

FIG. 14 is an elevation view of the back side of the one part panel left hand top corner.

FIG. 15 is an elevation view of the back side of the one part panel right hand top corner.

FIG. 16 is the elevation view of the back side of the one part panel left hand bottom corner.

FIG. 17 is the elevation view of the back side of the one part panel right hand bottom corner.

FIG. 18 is an elevation view of the vertical zipper viewed from the front side of the curtain. The back of the invisible coil zipper facing the room (flat side of the zipper).

FIG. 19 is an elevation view of the vertical zipper, viewed from the front side of the curtain, with the narrow zipper flap covering the flat zipper tape.

FIG. 20 is an elevation view of the vertical zipper viewed from the front side of the curtain, the wide zipper cover covering the narrow zipper cover, thus covering the zipper tape.

FIG. 21 is a cross section view of the vertical invisible zipper and flaps covering the zipper, only showing the flaps covering the flat side of the zipper which faces the room.

FIG. 22 is a cross section view of the zipper, showing the narrow zipper flap too wide and pushing the wide zipper flap upward on the flat side of the zipper facing the room.

FIG. 23 is a cross section view of the zipper, showing the narrow zipper flap too narrow and not able to cover the zipper when the panels are not attached vertically, on the flat side of the zipper facing the room, thus leaving the zipper exposed.

FIG. 24 is a cross section view of the zipper, showing the narrow zipper flap covering the zipper to the edge, while using thick fabric and balancing the thickness of the fabric with added fabric under the seam of the wide flap, on the flat side of the zipper facing the room.

FIG. 25 is a cross section view of the zipper, showing the narrow zipper flap covering the zipper to the edge, the wide zipper flap covering the narrow zipper flap and the wide zipper flap close to the seam of the narrow flap, on the flat side of the zipper facing the room.

FIG. 26 is a cross section view of the zipper, showing the both zipper flaps meeting in the middle not overlapping, with the protruding zipper facing the window, not recommended.

FIG. 27 is an elevation view of vertical zipper, detailing the zipper, zipper tape and zipper flap covers, thus showing the side of the zipper which protrudes and faces the window.

FIG. 28 is an elevation view of the vertical zipper showing the zipper covered by both the narrow and wide zipper flaps, with the zipper protrusion facing the window.

FIG. 29 is a cross section view of the vertical zipper flaps covering the protruding side of the zipper facing the window.

FIG. 30 is a cross section view of the vertical zipper showing the zipper covered by the flaps on both sides. This cross section is a combination of FIG. 25 and FIG. 29.

FIG. 31 is an elevation view of the grommet curtain, showing the “S” curve of the curtain with the crest and trough. The view is from the front of the curtain facing the room.

### DETAILED DESCRIPTION OF THE INVENTION

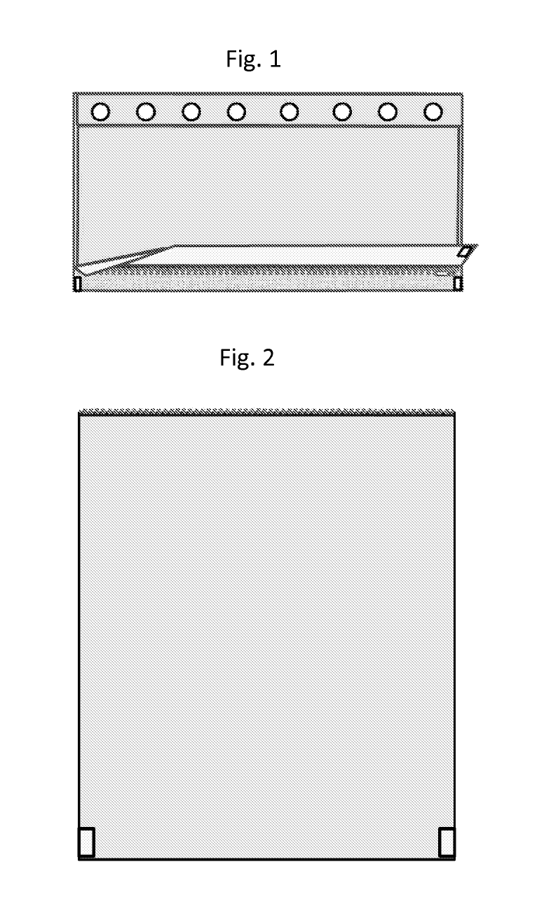

FIGS. 1 and 2 are elevations of the two part panel, back side view, facing the window, with one horizontal zipper.

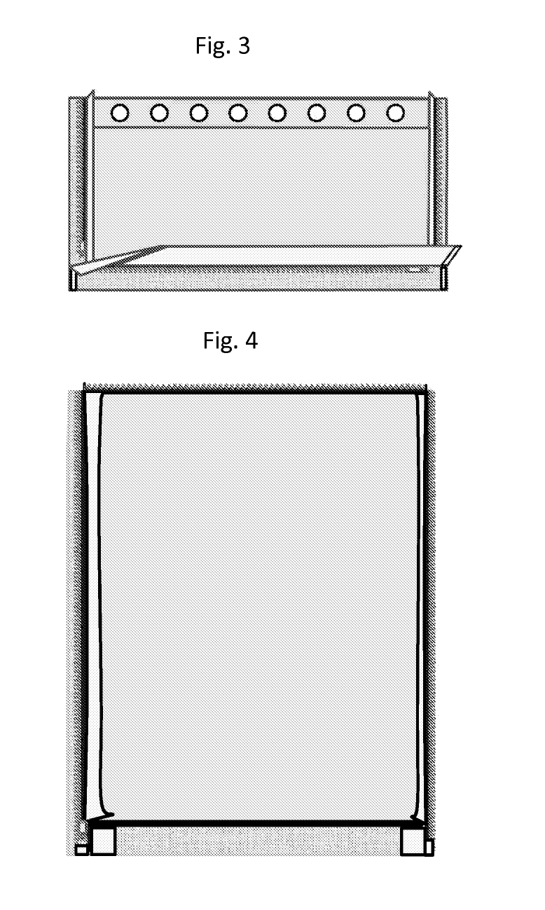

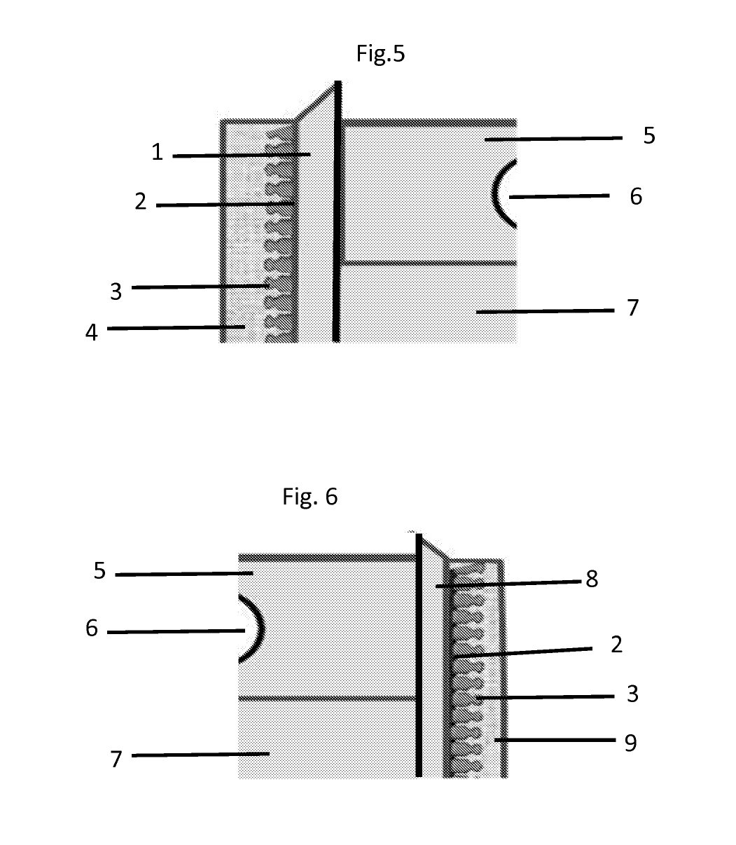

FIGS. 3 and 4 are elevations of the two part panel, back side view, facing the window with horizontal and vertical zippers. Showing the construction of the top and bottom panel parts with the horizontal and vertical functionality of the zippers. FIG. 5-12 gives details of each section.

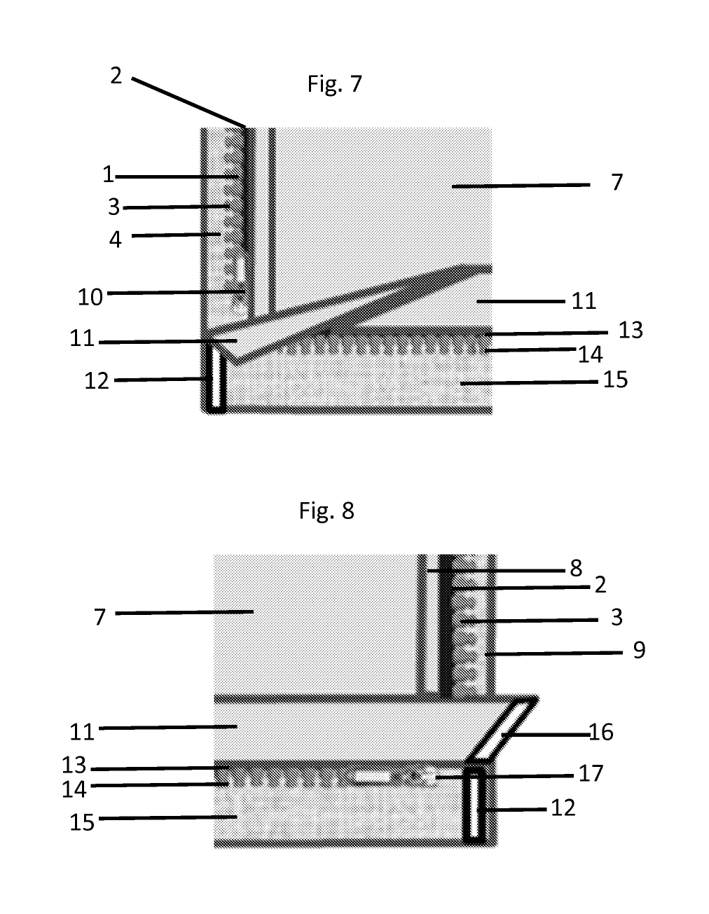

FIGS. 5 and 6 are elevations of the top panels, top part, back side view. 1 lining vertical zipper flap and 4 front side vertical zipper flap, extend from side to side of the top panel. Panels are attached vertically on the left or right side by 3 vertical zippers, thus covered by zipper 1 lining and 4 front vertical zipper flaps. Vertical flaps on either side of the panel are of different widths, thus the larger flap will cover the narrower flap and zipper. Panels with horizontal and vertical zippers, the top part of the panel may be slightly wider than the bottom panel, so 4,9 front zipper flaps and the 1,8 lining zipper may protrude on the sides slightly over the bottom. 3 zipper does not extend from side to side of the panel, since it is intercepted by 14 vertical zipper and 17 zipper pull (seen on FIGS. 7 and 8). The 5 grommet tape does not extend from side to side, since it is also intercepted by the vertical zippers. The area of the 5 grommet tape can be equally used for other curtain types such as pinch or tab. The 6 grommet holes must be strategically placed in order to make sure the vertical seams attach in the correct placement and stay undetectable, unnoticed and keep the natural flow of the curtain. 7 lining is sewn to the grommet tape and to the vertical zippers.

FIGS. 7 and 8 are elevations of the top panels, bottom part, back side view of the panel. 1 left zipper lining flap, 7 lining, 8 right zipper lining flap, 11 horizontal zipper flap are part of the lining. At the bottom of the top panel, the 11 horizontal zipper flap lining is not attached onto the 15 front fabric. The 13 horizontal zipper tape and 14 horizontal zipper are sewn onto the lining, close to bottom edge, thus providing a 11 lining flap to overlap, thus providing a full cover on the back, therefore if blackout lining is used, it will cover the light which may otherwise come through the panel and panel zipper area. The 11 lining horizontal flap hangs to approximately the same length as the front fabric, facing the room, which will overlap the top edge of the bottom panel. The 12, 16 fabric hook and loop fasteners are attached to edges of 15 front fabric and 11 lining flap keep the 3 zippers and 17 zipper pull hidden.

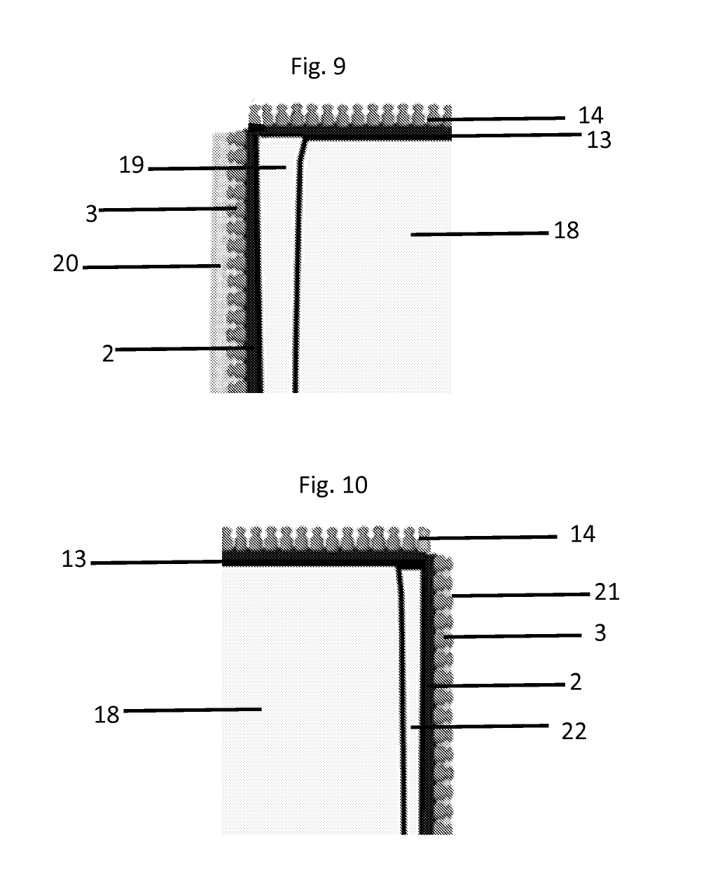

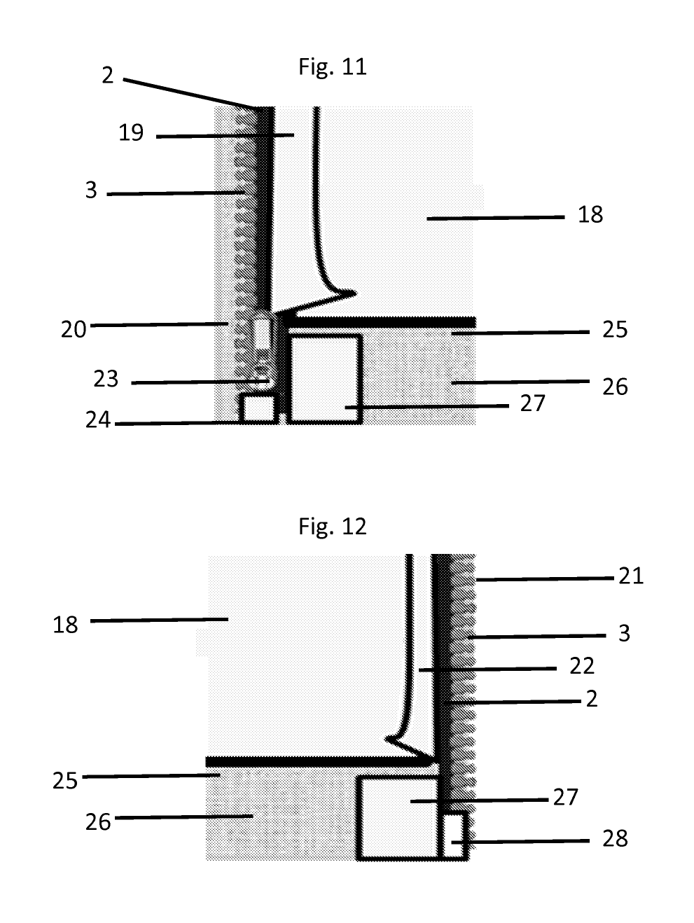

FIGS. 9 and 10 are elevations the bottom panel, top corner sections, viewed from the back side of the panel. 18 lining and 26 front side fabric (see on FIG. 11) are seamed onto the 13 horizontal zipper tape, and 2 vertical zipper tape. 21 narrow zipper flap must be approximately the same width as the 3 zipper, if too wide, the 21 zipper flap will push upwardly the adjoining 20 zipper flap and expose the zipper. The 19, 22 lining zipper flaps do not extend from side to side of the panel. At the point of intersection between top and bottom panel parts, 12,16 fabric hook and loop attach to cover 14 horizontal zippers connectors, 3 top and bottom zippers connectors and 17 zipper pull.

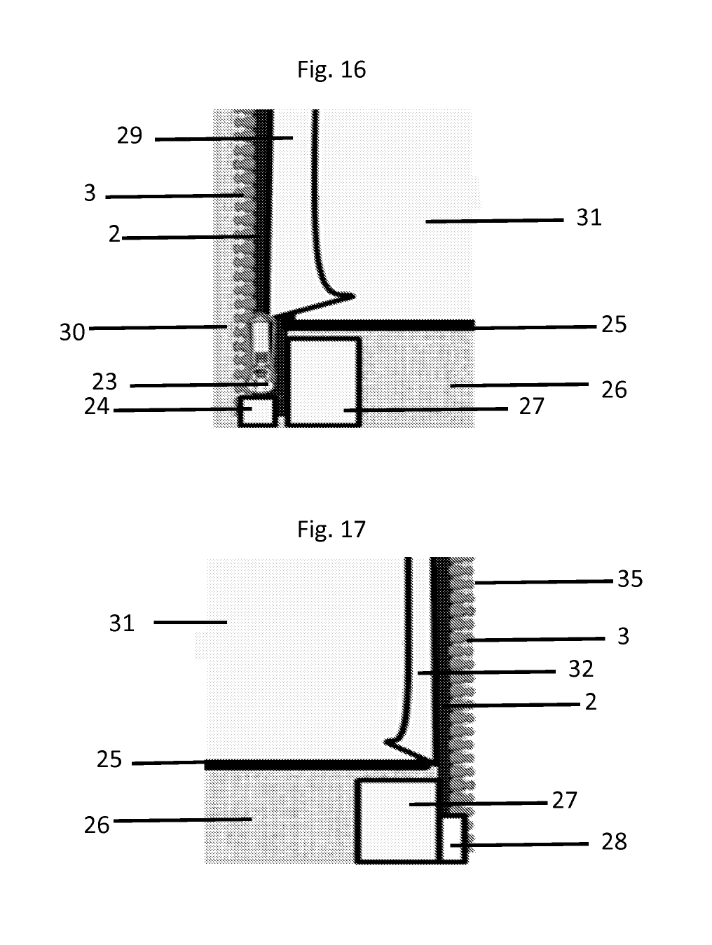

FIGS. 11 and 12 are elevations of the bottom of the two part panel, bottom corner sections, viewed from the back side of the panel. 25 bottom lining edge is not sewn to the 26 front side material. The 18 lining is optional on the bottom of the two part panel and on the one part panel. The 23 zipper pull is located on the widest zipper flap cover side, enabling 23 zipper pull to be hidden. The 23 zipper pull can be left hanging throughout the length of the panel, except at the bottom, where the pull may be visible. Below the 23 zipper pull, is 24 box (part of the “box and pin”) to attach and detach the zipper connectors. The 24 box is opposite corner 28 pin (part of the “pin and box”), the 3 zipper connectors are attached from the bottom edge with 24 box and 28 pin and zipped upward attaching two or more panels vertically. All bottom parts, of the two part panel and one part panel (see FIGS. 16 and 17) will have a 27 weight pocket at the bottom right and left sides corners next to the 24 box and 28 pin. The 27 weight pocket accommodates the suited weight to weigh down the corners of the panels and keep the 3 zippers straight. 26 front side fabric and 18 lining attached to the 2 zipper tape causing tension and stress on the 2 zipper tape and 3 zipper area, thus constricting the area, therefore the weights in 27 weights pockets will help the bottom corners of the panel from pulling up, plus prevent further budding, warping or contortion. Weights can be changed or replaced with heavier weights if necessary to further weight down the corners, the horizontal zipper or the vertical zippers.

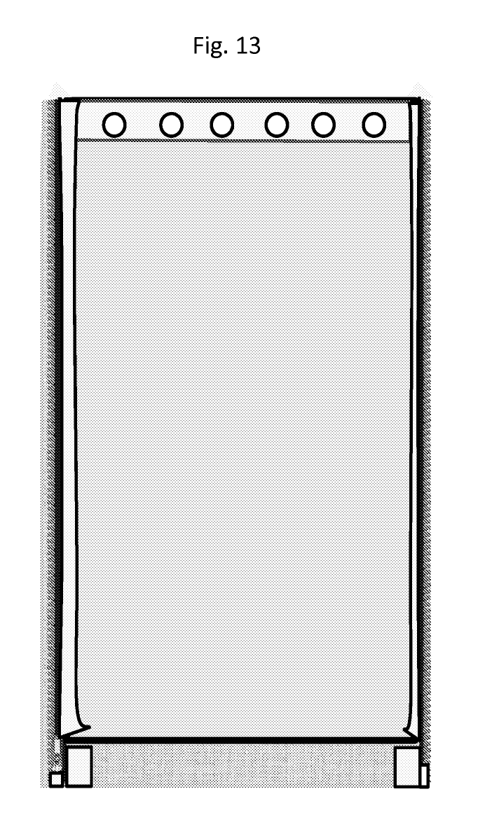

FIG. 13 is an elevation of the back side of the one panel curtain, showing all the details of how the panel attaches to another panel side by side to make a wider panel. The one part panel is partly a combination of the (FIGS. 1 and 2) two part panel made into one panel, it can only be made wider, however not longer.

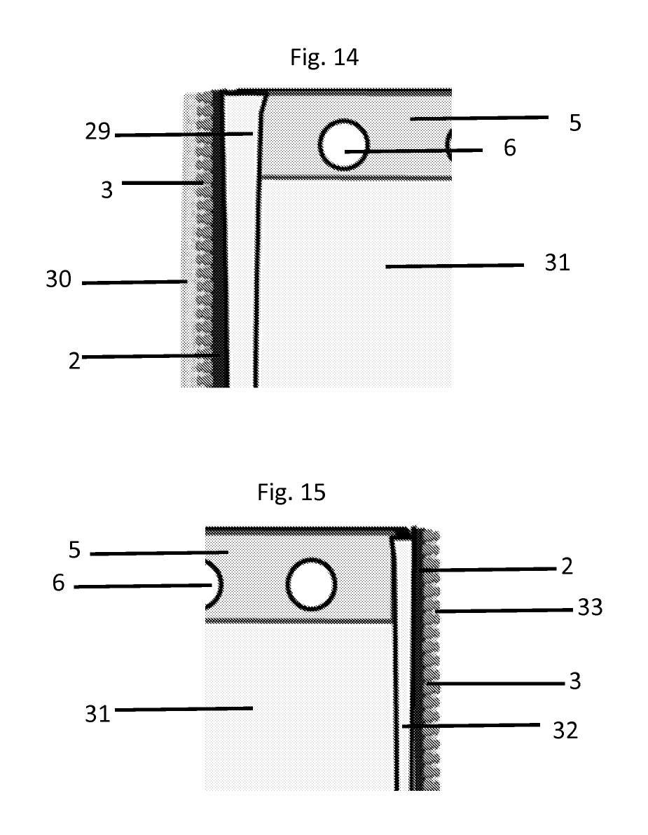

FIGS. 14 and 15 are elevations of the top right and left sides of the one part panel back side facing the window. The 3 zipper and 2 zipper tape extend vertically from side to side of the panel. 29, 32 lining zipper flap do not extend to the bottom of the panels; however, 30,33 front zipper flaps extend vertically from side to side of the panel. 31 lining is optional on the one part panel, same as for the bottom part of the two part panel.

FIGS. 16 and 17 are elevations of the bottom corners of the one part panel. The specification are the same as for FIGS. 11 and 12, differences in enumeration occur since both the two part panels top part and one part panels top areas are different, thus stated on FIGS. 9 and 10 and FIGS. 14 and 15. 29, 32 lining zipper flap, which is optional, starts from the top edge of the panel versus FIGS. 9 and 10, where 19,22 lining zipper flap, does not start from the top edge and 30, 35 zipper flap front side extends from side to side of the panel, versus FIGS. 9 and 10, where 20,21 zipper flap front side does not extend from side to side of the panel.

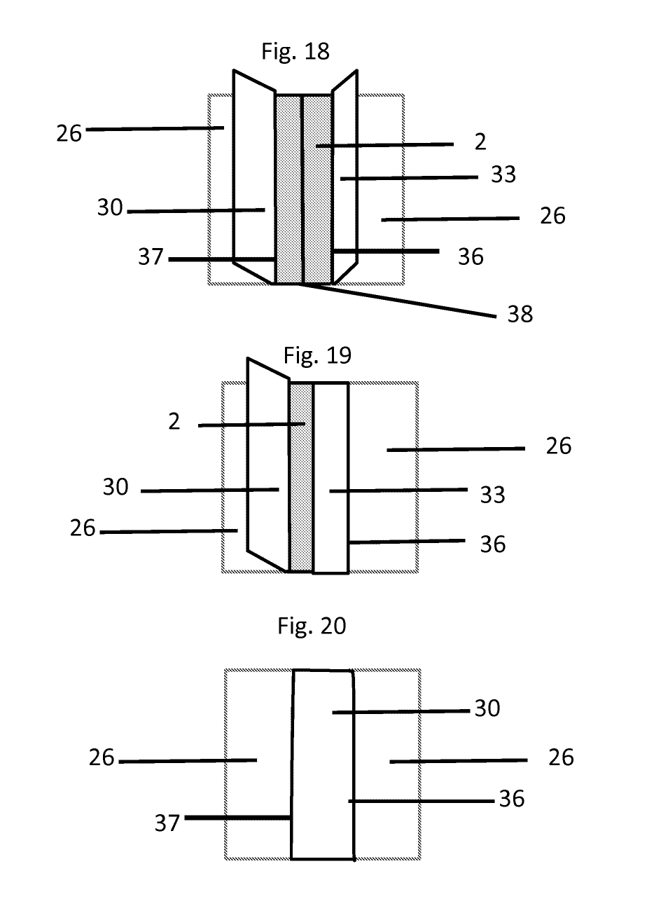

FIGS. 18, 19 and 20 are elevations showing the vertical zipper union front side view of the curtain facing the room. The 2 zipper tape of the invisible zippers flat side facing the room, 33 narrow zipper flap covers part of the zipper tape, however the length of 33 zipper flap should not extend, or approximate 37 zipper flap seam on the 2 zipper tape. 30 wide front side zipper flap will cover 33 narrow front side zipper flap to approximately 36 narrow front side zipper flap seam of 33 narrow front side zipper flap. If 30 wide front side zipper flap is too long it is easier to open, if too short, it exposes the 36 narrow zipper flap seam, plus 38 front side zipper gap, thus making the seam more noticeable. The only zipper used for all vertical areas of the curtain is an invisible coil open ended zipper or similar. The back of the zipper is flat (faces the front side of the room), there are no protrusions to lift 33 and 30 front side zipper flaps covering it. 30 wider zipper flap and 33 narrow zipper flap are continuations of 26 front fabric material facing the room.

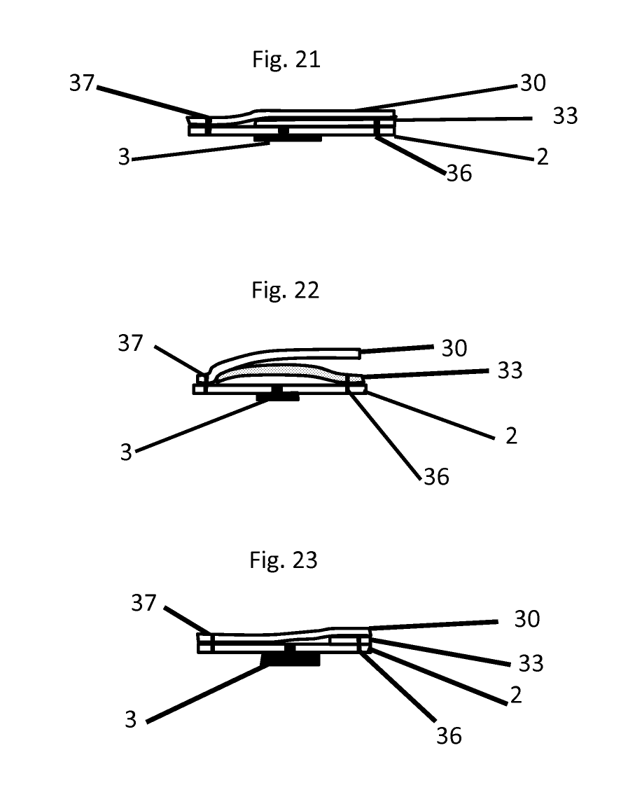

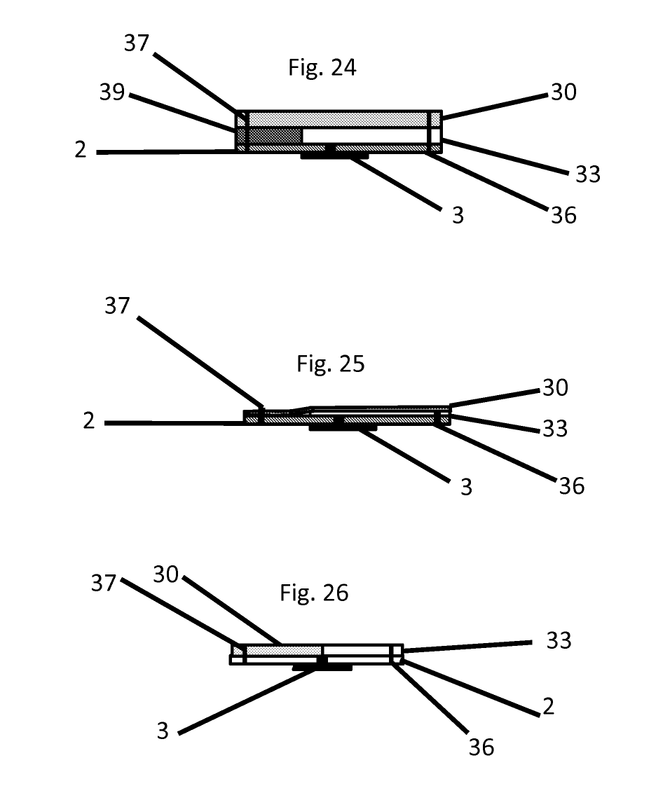

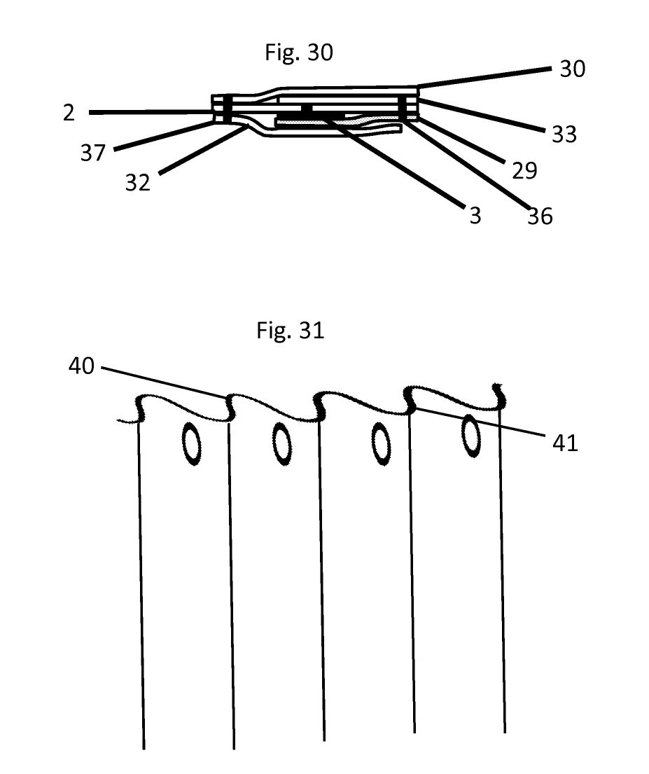

FIG. 21 illustrates FIG. 20 elevation in a cross section, only the flat side of the zipper tape, facing the room are shown on this illustration (all zipper flaps (front side and lining) on both sides of the zipper are specified on FIG. 30). 3 zipper faces the back of the curtain toward the window, 2 zipper tape and 36 narrow zipper flap seam are attached to the 33 front narrow zipper flap which covers up to the edge of 3 zipper coil connector; 2 zipper tape and 37 wide zipper seam is attached to 30 front side wide zipper flap which covers 33 front side narrow zipper flap with the option of extending over 36 narrow flap seam sewn to 33 front side narrow zipper flap. This illustration would is meant for thin fabrics, versus thicker fabrics, which will be illustrated in FIG. 24.

FIG. 22 illustrates in a cross section detailing the zipper facing the front of the room, 33 front narrow zipper flap is too long and forces 30 front side wide zipper tape upward, making the seam more apparent.

FIG. 23 illustrates in a cross section detailing the zipper facing the front of the room, 33 front narrow zipper flap is too narrow, when the panel is attached to another panel vertically, it would be fine, however then the panel vertical side is not attached, the 3 zipper coil will become visible.

FIG. 24 illustrates in a cross section detailing the zipper facing the front of the room, 2 zipper tape and 37 wide zipper seam, attached to 30 front side wide zipper flap cover and 39 added fabric to compensate the fabric thickness thus making 30 wide zipper flap cover 33 narrow zipper flap, a flatter surface, and avoid 37 front side wide zipper flap from opening and bringing the attention to the zipper union.

FIG. 25 illustrates in a cross section detailing the zipper facing the front of the room, 33 front side narrow zipper flap material is thin (note FIG. 24 with thicker material), the 30 overlapping front side wide zipper flap can remain closed without further exposing the zipper union.

FIG. 26 illustrates in a cross section detailing the zipper facing the room, 30 and 33 both zipper flaps of equal size covering the zippers flat side facing the room. The zipper flap is not wide enough to cover the zipper pull from the front side of the curtain facing the room, and the flaps covering the zipper will not be able to keep closed throughout the length of the curtain, thus exposing the zipper tape. This example illustrates the zipper flaps meeting in the middle will not work for this specific product.

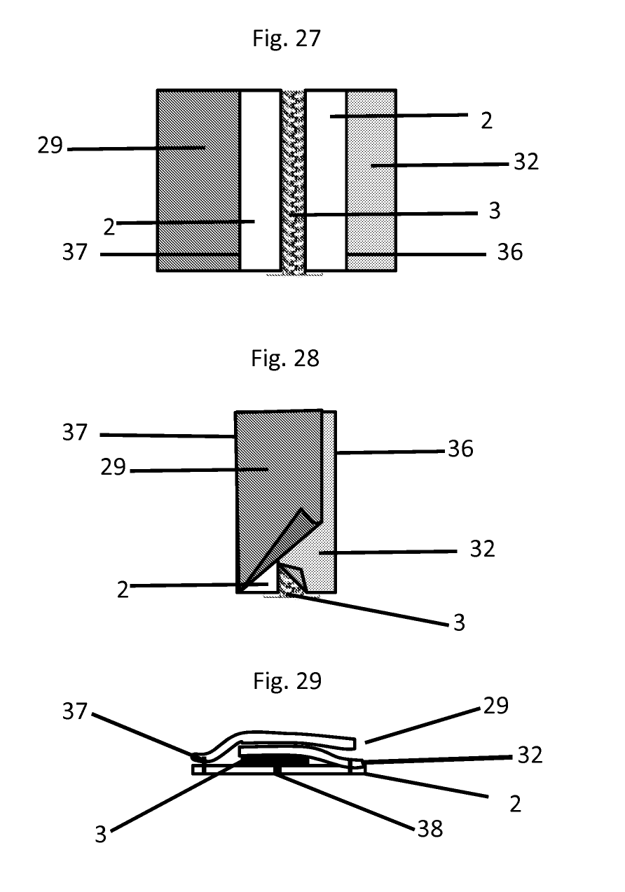

FIG. 27 illustrates an elevation of the zipper from the back view of the curtain, facing the window. 29 back side wide zipper flap and 32 back side narrow zipper flap will be folded over the 3 back side protruding zipper coils and 2 zipper tape, thus covering the 3 back side protruding zipper.

FIG. 28 illustrates an elevation of the back view of the curtain with 29 wide zipper flap covering partially 32 narrow zipper flap, which it turn covers 2 back side zipper tape and 3 back side protruding zipper coils. The 29 back side wide zipper cover is intended to cover the 3 back side protruding zipper coils from light coming through the gap, if blackout lining in needed, not for reasons of making the seam undetectable or unnoticeable.

FIG. 29 illustrates in a cross section of elevation FIG. 28 illustrating the details of the 3 back side zipper coil protrusion covered by 32 back side narrow zipper flap and 29 back side wide zipper flap.

FIG. 30 illustrates a cross section detailing of both front and back sides of the zipper area, with 33,30 front side zipper flaps and 29,32 back side zipper flaps covering the zipper.

FIG. 31 illustrates an elevation of the natural “S” curve (like a wave) with the 40 trough (bottom of the curve) and the 41 crest (top of the curve). The vertical zippers unions area allocated throughout the curves to allow for the best location to keep the 30 front side zipper flap covering the 3 zipper union undetectable or unnoticeable.

What is claimed is:

1. A modular panel window dressing system of inter-connectable fabric panels to construct a window curtain to cover a desired size window length or width comprising individual curtain panels, each panel comprises at least one rectangular or square part, attached horizontally or vertically to each other by means of a flexible zipper remaining undetectable or unnoticeable when viewed from the front, facing the room; different types of panels can be made, such as: a one part panel, comprising vertical zipper connectors detachably connect to each other to form a custom width, with a front side fabric, which faces into the room and with optional back side fabric (referred to as lining), which faces the window; whereas a panel, connected by means of a horizontal zipper, comprising at least two parts (referred to as: two part panel), with a top part panel and a bottom part panel, wherefore the top part panel is made of a sheet of fabric having a front side fabric, which faces into a room, and a lining, which faces a window, thus the bottom part panel comprising a sheet a fabric having a front side fabric and an optional lining, furthermore the two part panel has the option of horizontal and vertical zippers, thus having the ability to change width, as well as length.

2. The system as defined in claim 1, wherein the two part panel, the top part panel front fabric and lining are sewn or attached horizontally at the top area of the top part panel, located in the proximity of the top panel suspension from the horizontal rod, thus at least one side of a horizontal zipper connector attaches to the lower end the curtains top panels lining, and at least one zipper connector attaches along the horizontal top edge of the bottom panel, therefore providing the necessary gap, distance and aperture between the front fabric and lining, and allowing the stiffness of the zipper to translate onto curtains lining and not front side fabric, therefore allowing the natural curves of the curtain to remain unchanged on the top panel front side fabric, making the horizontal zipper undetectable or unnoticeable.

3. The system as defined in claim 1, wherein the two part panel, the bottom panel is not heavy enough or large enough to keep the natural flow of the curtain, thus showing the stiffness of the horizontal zipper which is translated onto the front fabric, therefore additional weight is added onto the bottom panels weight pocket (small pocket located in the proximity of the bottom corner of the bottom part of the two part or one part panel, next to the zipper connectors) to create the needed weight to keep the zipper undetectable or unnoticed; furthermore, in order to avoid stubborn or unyielding vertical zippers from shifting or migrating toward the area of the panels waves crest, more weight is added onto the appropriate weight pocket, thus counteracting the zippers stress or pull, thus keeping the vertical zipper undetectable or unnoticeable.

4. The system of claim 3, wherein the one and two part panel, weight is added at the bottom area to keep the natural flow of vertically attached panels, in addition, reinforcing and supporting fabric is added for rigidity located at the top of the vertical zipper connectors, where the panels are suspended from the rod, to reinforce the vertical union in order not to sag, droop or distort.

5. The system as defined in claim 1, wherein on the two part panel, the top part panels lining is attached to the bottom part panel by means of a horizontal zipper, different types of flexible zippers with synthetic zipper tapes (used for their dimensional stability in relation to heat and humidity, versus cost) can be used, such as: coil, plastic-molded or similar flexible zippers which can be found in the market, however other fasteners, which have already been tested such as: fabric hook and loop, buttons, single snaps, snaps with tapes, hooks are not an alternative to be used as a horizontal fasteners, since they lack either flexibility, gaps, too time consuming to attach or detach, lack of uniformity or a combination thereof.

6. The system of claim 1, wherein on the two part panel, the vertical and horizontal zippers located on top part panels bottom corners which approximate each other vertically and horizontally do not extend from side to side of the panel, however in order to make the zippers undetectable or unnoticeable, first, the top panels front fabric extends lower than the lining, thus covering both zippers and zipper pulls from frontal view, and second, a small fastener, such as a fabric loop and hook or similar is attach on the sides, to hide and enclose the intercepting vertical and horizontal zippers from a side view.

7. A system as defined in claim 1, wherein a method to vertically attach curtain panels, thus consisting of one panel comprising two vertical zipper connectors, wherein the panels are vertically interconnected by specific zipper types and zipper tape which will not distort, contort, pucker or warp, therefore the zippers stay straight, extended, even and flat in form to remain undetectable or unnoticed, thus the vertical zipper type (all vertical zippers are referenced to this zipper type) comprising a coil, invisible, open ended, flat side (one side the zipper does not protrude) or similar (with comparable type of flexibility of a coil zipper, which is inherently different from most flexible zippers), the zippers and components (including the zipper tape, and pin and box) are made of nylon, polyester or a similar synthetic material which keeps dimensionally stable (resisting to stretching, shrinking or contorting) when exposed to moisture, water or reasonable heat (compared to the heat of a clothes drying machine), whereas after testing many different types of fasteners such as: fabric hook and loop, buttons, single snaps and snaps on tape, such fasteners are not considered an alternative, since they either lack flexibility, buckle, warp, twist, have gaps, arch, deform or a combination thereof, comprising panels vertically attached or not attached to another panel (the vertical zipper connector is not attached to another vertical zipper connector), plus after testing various different types of zippers in different positions, lengths, zipper and zipper tape material, zipper size, or a combination there of, stating that any zipper or flexible zipper can be used as an alternative to achieve the same result, is very inaccurate, since most zippers and their components are different and perform different, specifically when using longer zippers that are hanging freely, such as vertically hanging curtain panels, which do not have any support (leaning against or laying on top of an object), in addition, the guidelines or criterion of comparing two panels of fabric attached by fasteners on pillows, comforters or clothing articles is very different from that of modular curtain panels, since the parameters of such products are considerably different.

8. The system of claim 7, wherein the vertical zipper has a flat side or a side that does not protrude facing the room, thus helping prevent the zipper flaps from opening and keeping the zipper undetectable or unnoticeable.

9. The system of claim 7, wherein the location of the vertical zipper union, covered by the wider of the two zipper flaps, is located close to the middle of the trough (bottom of the “S” wave) or on the trough itself, thus the wider flap flows on the angle down, opening from the direction of the crest toward the trough, or on the trough itself, however the larger flap should not be located from the trough upward toward the crest or on the crest, thus keeping the vertical zippers undetectable or unnoticed.

10. The system of claim 7, wherein each vertical zipper flap (left and right side of the panel), have different widths, each flap has an established size to ensure the zipper is covered and remains covered and conceals the seams, therefore the width of the narrow flap (sewn onto the zipper tape and reaches up to approximately the edge of the coil zipper) should be less than ½ the width of the zipper and zipper tape, and the width of the wider flap (sewn onto the opposite vertical side of the panel, thus covering and overlapping the narrow flap when the panels are attached vertically) should be less than the entire width of the zipper tape, therefore the width of the flaps are based on standard width of invisible coil zippers.

11. The system of claim 10, wherein the panel(s) attaching vertically, the front side fabric is thick, thus keeping the vertical zippers, once attached to each other more difficult to conceal, therefore added fabric is sewn beneath the area where the larger flap is sewn onto the zipper tape, thus helping prevent the larger zipper flap from opening and exposing the vertical zipper.
